(19) United States
(12) Patent Application Publication
(10) Pub. No.: US 2007/0188867 A1
(43) Pub. Date: Aug. 16, 2007

(54) Eyepiece lens group of a riflescope system

(75) Inventors: Chen-Chen Liao, Taichung (TW); Shang-Yung Liang, Taichung (TW)

Correspondence Address: John Chen, Room 303, 3F., No 25, Sec. 1, Changan E. Road, Taipei, 10441, TW

(73) Assignee: ASIA OPTICAL CO., INC.

(21) Appl. No.: 11/353,196

(22) Filed: Feb. 14, 2006

(51) Int. Cl. G02B 27/64

(52) U.S. Cl. 359/556; 359/643

(57) ABSTRACT

An eyepiece lens group in a riflescope system comprises, from a front, eye side to a rear, object side, a glass lens and a plastic lens. The plastic lens has an aspherical surface and a diffractive surface, wherein the diffractive surface is on the front surface of the plastic lens and the aspherical surface is on the rear surface of the plastic lens. The aspherical surface of the plastic lens is utilized to abate the aberration. The diffractive surface of the plastic lens is utilized to abate the chromatic aberration. Therefore, the total numbers of lenses of the eyepiece lens group in the riflescope system could be reduced and the weight of the riflescope system could be reduced.

### BACKGROUND OF THE PRESENT INVENTIONIN

1 . Field of Invention

The present invention relates to an eyepiece lens group of a riflescope system, and more particularly to an eyepiece lens group of ariflescope system utilizing a plastic lens having aspherical and diffractive surfaces instead of glass lens.

2 . Description of Related Arts

Conventional riflescope systems are composed of a number of glass lenses, and these have prevented the reduction of the weight, size, and cost of such viewfinder optical systems. These inconveniences can be overcome by reducing the number of constituent lens elements.

However, the reduction of the number of lens elements and the use of plastic lenses make it more difficult to correct aberration satisfactorily. In particular, chromatic aberration, which can be corrected only with a combination of lenses made of materials having different dispersion, is difficult to correct with a reduced number of lens elements or with plastic lenses. In addition, since there are only few kinds of plastic that can be used satisfactorily as lenses, it is not possible to freely select plastic materials having different dispersions for the correction of chromatic aberration. Accordingly, it is difficult to use plastic lenses for all the lens elements constituting an optical system.

Furthermore, there is deterioration in the image-formation performance of a typical riflescope system due to the environmental conditions such as temperature and/or humidity. Hence a typical riflescope system utilizes glass lenses in order to avoid the deterioration in the optical performance due to the environmental conditions such as temperature and/or humidity. FIG. 1 is a cross-sectional view and optical paths of a conventional riflescope system. Referring to FIG. 1 of the drawings, in the conventional riflescope system, there are three lens groups, an eyepiece lens group 110, an erector lens group 120, and an objective lens group 130. The standard eyepiece lens group 110 has three glass lenses, a convexo-convex lens 111, a convexo-convex lens 112, and a concavo-concave lens 113. The erector lens group 120 has five glass lenses. Meanwhile, as to the construction of the erector lens group 120, it is desirable that it comprises, in this order from the object side, a first lens in the form of a meniscus positive lens convex toward the eyepoint side, a second lens in the form of a meniscus positive lens concave toward the eyepoint side, a third lens which is a convexo convex lens, a fourth lens which is a convexo convex lens, and a fifth lens in the form of a meniscus positive lens convex toward the eyepoint side. The erector lens group 120 permitting a predetermined ratio of change of the magnification and good stability of optical performance is to be achieved. The objective lens group 130 has three glass lenses. Meanwhile, as to the construction of the objective lens group 130, it is desirable that it comprises, in this order from the object side, a first lens which is a convexo convex lens, a second lens in the form of a meniscus positive lens concave toward the eyepoint side, and a third lens which is a convexo convex lens.

As mentioned above, conventional riflescope systems are composed of a number of glass lenses, and this has prevented the reduction of the weight, size, and cost of such riflescope systems. The conventional riflescope system utilizes cemented lenses in order to abate chromatic aberration, however, this process increases the weight and cost of such riflescope system.

It is therefore attempted by the applicant to deal with the above situation encountered with the prior art in order to reduce the weight and cost and maintain the same optical performance of such riflescope system.

### SUMMARY OF THE PRESENT INVENTION

A main object of the present invention is to provide an eyepiece lens group of a riflescope system employing a plastic optical lens having aspherical and aiffractive surfaces such that the total numbers of lenses in the riflescope system could be reduced and the weight of the riflescope system could be reduced.

Another object of the present invention is to provide a riflescope system employing two lenses instead of conventional eyepiece lens group which has three glass lenses, a convexo-convex lens and a cemented lens composed of the convexo-convex lens and the concavo-concave lens, wherein one is a glass lens and the other is a plastic lens. The plastic lens has an aspherical surface and a diffractive surface.

Another object of the present invention is to provide a riflescope system employing two lenses instead of conventional eyepiece lens group to reduce the weight and cost and maintain the same optical performance of such riflescope system, wherein the injection molding process of the plastic lens is simplified and the manufacturing cost can be reduced.

Accordingly, in order to accomplish the above objects, the present invention provides an eyepiece lens group in a riflescope system, comprising, from a front, eye side to a rear, object side, a glass element and a plastic element. The plastic element has an aspherical surface and a diffractive surface, wherein the diffractive surface is on the front surface of the plastic element and the aspherical surface is on the rear surface of the plastic element.

These and other objectives, features, and advantages of the present invention will become apparent from the following detailed description, the accompanying drawings, and the appended claims.

### BRIEF DESCRIPTION OF THE DRAWINGS

FIG. 1 is a cross-sectional view and optical paths of a conventional riflescope system.

FIG. 2 is a cross-sectional view and optical paths of a riflescope system according to a preferred embodiment of the present invention.

### DETAILED DESCRIPTION OF THE PREFERRED EMBODIMENT

In the following detailed description of the present invention, numerous specific details are set forth in order to provide a thorough understanding of the present invention. However, it will be obvious to one skilled in the art that the present invention may be practiced without these specific details. In other instances well known methods, procedures, components, and circuits have not been described in detail so as not to unnecessarily obscure aspects of the present invention.

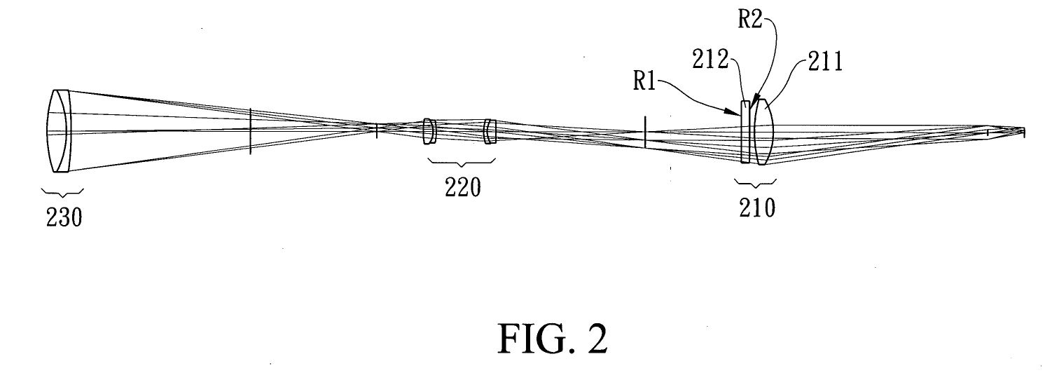

Referring to FIG. 2 of the drawings, a cross-sectional view and optical paths of a viewfinder optical system according to a preferred embodiment of the present invention is illustrated, in which the viewfinder optical system comprises three lens groups, an eyepiece lens group 210, an erector lens group 220, and an objective lens group 230. The conventional eyepiece lens group 110 which has three glass lenses, a convexo-convex lens 111, a convexo-convex lens 112, and a concavo-concave lens 113, is replaced by two lenses according to the preferred embodiment of the present invention. As shown in FIG. 2, the eyepiece lens group 210 has two lenses, wherein one is a glass lens 211 and the other is a plastic lens 212. The plastic lens 212 has an aspherical surface R1 and a diffractive surface R2. In the prior art, the conventional viewfinder optical system usually utilizes a lot of lenses to correct the aberration, however, in this present invention the aspherical surface R1 of the plastic lens 212 is utilized to abate the aberration. In the prior art, the conventional viewfinder optical system usually utilizes a lot of lenses with different dispersion coefficients to correct chromatic aberration in order to obtain good correction of chromatic aberration, however, in this present invention the diffractive surface R2 of the plastic lens 212 is utilized to abate the chromatic aberration. From a front, eye side to a rear, object side, the front surface of the plastic lens 212 is the diffractive surface R2 and the rear surface of the plastic lens 212 is the aspherical surface R1.

Further, the aspherical surface R1 and the diffractive surface R2 divided to be manufactured on the both sides of the plastic lens 212 could reduce the tolerance of the manufacturing process which is secured for manufacturing errors in order to raise the quality of the optical performance. In addition, when the lens 212 is structured by the plastic material, the mass production by the injection molding becomes possible, thereby, a low cost eyepiece lens can be obtained. Hence, the cemented lens composed of the convexo-convex lens 112 and the concavo-concave lens 113 could be replaced by the plastic lens 212 without the manufacturing process for producing a cemented lens. In fact, the manufacturing process for producing a cemented lens is very complicated. To sum up, in this present invention the injection molding process of the plastic lens 212 is simplified, and the manufacturing cost can be reduced. Furthermore, the location of the glass lens 211 is placed at the outside of the plastic lens 212 in order to prevent the damage of the plastic lens 212 from the ambient. Additionally, the glass lens 211 provides the main optical power in the eyepiece lens group 210.

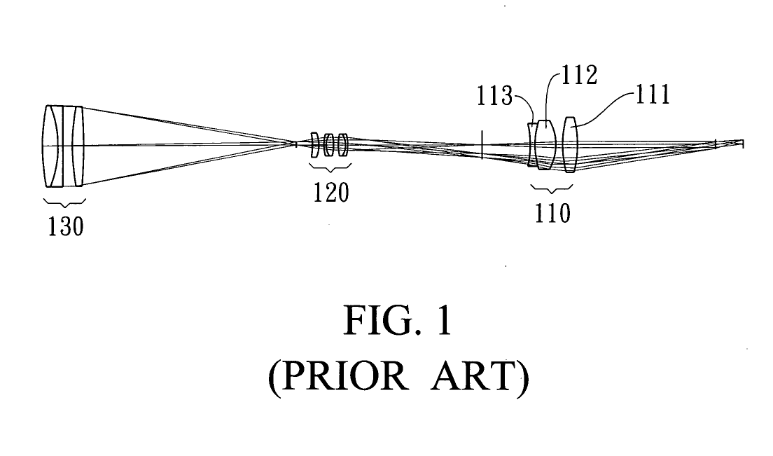

The functions of the erector lens group 220 and the objective lens group 230 are the same to the erector lens group 120 and the objective lens group 130 as shown in FIG. 1. According to the preferred embodiment of the present invention, even though the best mode is that from a front, eye side to a rear, object side, the front surface of the plastic lens 212 is the diffractive surface R2 and the rear surface of the plastic lens 212 is the aspherical surface R1, the positions of the diffractive surface R2 and the aspherical surface R1 could be changed. In other words, it can be worked that from a front, eye side to a rear, object side, the front surface of the plastic lens 212 is the aspherical surface R1 and the rear surface of the plastic lens 212 is the diffractive surface R2.

In this invention, in order to the power of the eyepiece lens group 210 focusing on the plastic lens 212, it is preferable that the focus length fg of the glass lens 211 in the eyepiece lens group 210 and the focus length fp of the plastic lens 212 satisfy the following inequality:
|fg/fp|<0.5

When the |fg/fp| is near 0.5, it represents that the power of the plastic lens 212 is larger and the power of the plastic lens 212 is easily affected by the temperature. In addition, the tolerance of the manufacturing process is hard to control so as to affect the quality of the optical performance and good yield.

In addition, the proper field-of-view angle of the light striking the diffractive surface R2 is within two degrees and ten degrees under different magnifying powers of the diffractive surface R2. If the field-of-view angle is lower than the lower limit, the field-of-view angle is too small to design the viewfinder optical system. If the field-of-view angle is larger than the upper limit, there exist stray lights having different wavelengths to seriously affect the visual effect.

In this invention, the general aspheric equation for defining the sag(z) for all aspheric surface is:

$$z = \frac{{ch}^{2}}{1 + {[ 1 - ( k + 1 ) {c}^{2} {h}^{2} ]}^{\frac{1}{2}}} + A {h}^{4} + {Bh}^{6} + {Ch}^{8} + {Dh}^{10}$$

The coefficients for aspherical surface R1 are c=1/505.042, k=0, A=−5.172448E-06, B=6.805825E-10, C=−2.166406E-12, and D=0.

The diffractive surface is described by the following phase equation:

$$Φ ( h ) = \frac{2 π}{{λ}_{o}} [ {K}_{1} {h}^{2} + {K}_{2} {h}^{4} + {K}_{3} {h}^{6} + {K}_{4} {h}^{8} + {K}_{5} {h}^{10} ]$$

The coefficients for the diffractive surface R2 are K₁=8.0496114, K₂=5.060945E-3, K₃=0, K₄=0, and K₅=0.

From the forgoing descriptions, it can be shown that the above objects have been substantially achieved. The present invention effectively provides an effective and flexible means of converting digital signal into an analog signal in a resources and cost-effective manner.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An eyepiece lens group in a riflescope system, comprising, from a front, eye side to a rear, object side, a glass element and a plastic element, said plastic element having an aspherical surface and a diffractive surface, wherein said diffractive surface is on the front surface of said plastic element and said aspherical surface is on the rear surface of said plastic element.

2. The eyepiece lens group, as recited in claim 1, wherein said glass element is a glass lens.

3. The eyepiece lens group, as recited in claim 1, wherein said plastic element is a plastic lens.

4. The eyepiece lens group, as recited in claim 1, wherein said aspherical surface of said plastic element is utilized to abate the aberration.

5. The eyepiece lens group, as recited in claim 1, wherein said diffractive surface of said plastic element is utilized to abate the chromatic aberration.

6. The eyepiece lens group, as recited in claim 1, wherein a focus length fg of said glass element and a focus length fp of said plastic element satisfy the following inequality: |fg/fp|<0.5.

7. The eyepiece lens group, as recited in claim 1, wherein a field-of-view angle of a light striking said diffractive surface is within two degrees and ten degrees under different magnifying powers of said diffractive surface.

8. The eyepiece lens group, as recited in claim 1, wherein a aspheric equation for defining the sag(z) for said aspheric surface is:
$$z = \frac{{ch}^{2}}{1 + {[ 1 - ( k + 1 ) {c}^{2} {h}^{2} ]}^{\frac{1}{2}}} + A {h}^{4} + {Bh}^{6} + {Ch}^{8} + {Dh}^{10}$$
where the coefficients for said aspherical surface are c=1/505.042, k=0, A=−5.172448E-06, B=6.805825E-10, C=−2.166406E-12, and D=0.

9. The eyepiece lens group, as recited in claim 1, said diffractive surface is described by the following phase equation:
$$Φ ( h ) = \frac{2 π}{{λ}_{o}} [ {K}_{1} {h}^{2} + {K}_{2} {h}^{4} + {K}_{3} {h}^{6} + {K}_{4} {h}^{8} + {K}_{5} {h}^{10} ]$$
where the coefficients for said diffractive surface are K₁=8.0496114, K₂=5.060945E-3, K₃=0, K₄=0, and K₅=0.

10. An eyepiece lens group in a riflescope system, comprising, from a front, eye side to a rear, object side, a glass element and a plastic element, said plastic element having an aspherical surface and a diffractive surface, wherein said diffractive surface is on the rear surface of said plastic element and said aspherical surface is on the front surface of said plastic element.

11. The eyepiece lens group, as recited in claim 10, wherein said glass element is a glass lens.

12. The eyepiece lens group, as recited in claim 10, wherein said plastic element is a plastic lens.

13. The eyepiece lens group, as recited in claim 10, wherein said aspherical surface of said plastic element is utilized to abate the aberration.

14. The eyepiece lens group, as recited in claim 10, wherein said diffractive surface of said plastic element is utilized to abate the chromatic aberration.

15. The eyepiece lens group, as recited in claim 10, wherein a focus length fg of said glass element and a focus length fp of said plastic element satisfy the following inequality: |fg/fp|<0.5.

16. The eyepiece lens group, as recited in claim 10, wherein a field-of-view angle of a light striking said diffractive surface is within two degrees and ten degrees under different magnifying powers of said diffractive surface.

17. The eyepiece lens group, as recited in claim 10, wherein a aspheric equation for defining the sag(z) for said aspheric surface is:
$$z = \frac{{ch}^{2}}{1 + {[ 1 - ( k + 1 ) {c}^{2} {h}^{2} ]}^{\frac{1}{2}}} + A {h}^{4} + {Bh}^{6} + {Ch}^{8} + {Dh}^{10}$$
where the coefficients for said aspherical surface are c=1/505.042, k=0, A=−5.172448E-06, B=6.805825E-10, C=−2.166406E-12, and D=0.

18. The eyepiece lens group, as recited in claim 10, said diffractive surface is described by the following phase equation:
$$Φ ( h ) = \frac{2 π}{{λ}_{o}} [ {K}_{1} {h}^{2} + {K}_{2} {h}^{4} + {K}_{3} {h}^{6} + {K}_{4} {h}^{8} + {K}_{5} {h}^{10} ]$$
where the coefficients for said diffractive surface are K₁=8.0496114, K₂=5.060945E-3, K₃=0, K₄=0, and K₅=0.
